(19) United States
(12) Patent Application Publication
(10) Pub. No.: US 2026/0235564 A1
(43) Pub. Date: Aug. 13, 2026

(54) Correction of Retention Time Drift with Scout-MRM

(71) Applicant: DH Technologies Development Pte. Ltd., Singapore (SG)

(72) Inventors: Lyle Lorrence BURTON, Woodbridge (CA); David M. COX, Toronto (CA); Gordana IVOSEV, Etobicoke (CA); Yves LE BLANC, Newmarket (CA)

(21) Appl. No.: 19/471,489

(22) PCT Filed: Apr. 4, 2024
(86) PCT No.: PCT/IB2024/053309

§ 371 Date: Oct. 1, 2025

Related U.S. Application Data
(60) Provisional application No. 63/494,368, filed on Apr. 5, 2023.

(51) Int. Cl. G01N 30/86; G01N 30/72

(52) U.S. Cl. CPC G01N 30/8693; G01N 30/72; G01N 30/8658

(57) ABSTRACT

Systems and methods are provided for correcting a measured retention time or expected retention time of an ion intensity measurement. A measured sentinel retention time is received for each of a plurality of sentinel ion intensity measurements. During acquisition, sentinel analysis is performed. In sentinel analysis, a plurality of ion intensity measurements is divided into two or more groups so that different groups of the two or more groups are measured separately. At least one sentinel ion intensity measurement in each group of the two or more groups is selected to identify a next group of the two or more groups to be measured. A measured retention time or an expected retention time of at least one non-sentinel ion intensity measurement of the two or more groups is corrected using the plurality of measured sentinel retention times.

### RELATED APPLICATIONS

This application claims priority to U.S. Provisional Application No. 63/494,368 filed on Apr. 5, 2023, the contents of which are incorporated herein in their entirety.

### FIELD

The teachings herein relate to systems and methods for correcting a measured retention time or an expected retention time of an ion intensity measurement using a scout or sentinel ion.

### INTRODUCTION

### Retention Time Shifts During Sentinel Analysis

As described below, sentinel analysis is a method for triggering MRM transitions or MS/MS scans. It is not based on retention time. Instead, this method involves triggering a next group of MRM transitions or MS/MS scans to be executed based on the detection of a scout or sentinel transition or ion during an MRM transition or an MS/MS scan.

Retention time drift is inherent in any chromatography method. Even though sentinel analysis allows more robust data acquisition even in the presence of drift, it does not directly compensate for drift in downstream processing. As a result, even sentinel analysis can cause problems for downstream processing such as peak integration. Some peak integration algorithms rely on an “expected-RT” and “RT-window” to localize the peak of interest and accommodate for any “small shift” in these values.

FIG. 2 is an exemplary diagram 200 of a user interface from a peak integration program showing the reliance of the program on an expected retention time and a retention time window provided by a user. The user interface of FIG. 2 shows input field 210 for an expected retention time and input field 220 for a retention time window.

The expected-RT and RT-window values are typically set to narrow values to ensure that the proper peaks are integrated, and to avoid integration of closely eluting interferences that result in false data reporting. Consequently, any large shifts in retention time caused by any changes in chromatography conditions (gradient profile, column aging, or loading) can prevent peaks from being correctly detected.

As a result, there is a need for systems and methods to correct a measured retention time or expected retention time of an ion intensity measurement when using sentinels in data collection.

### Sentinel Analysis

Multiple reaction monitoring (MRM) or selected reaction monitoring (SRM) is a targeted acquisition method, as described below. In MRM, one or more transitions of a precursor ion to a product ion are predefined for compounds of a sample. As the sample is being introduced into the tandem mass spectrometer, the precursor ion of each transition of the one or more transitions is selected and fragmented and the product ion of each transition is mass analyzed, producing a product ion intensity for each transition.

MRM is often performed in liquid chromatography coupled mass spectrometry/mass spectrometry (LC-MS/MS) experiments that are used to identify or quantify one or more compounds of interest. When a complex sample that includes many different compounds of interest is analyzed, the number of MRM transitions used in the analysis may become large. Data is acquired in succession for each MRM transition beginning again with the first after data for the last is acquired; one group of sequential MRMs is referred to as a cycle. In order to reduce the number of MRM transitions that are performed in one cycle of a tandem mass spectrometer, a method for scheduling the MRM transitions was developed. This method is referred to as scheduled MRM.

In scheduled MRM, each MRM transition to be analyzed during the experiment is also assigned a retention time or retention time range. During the experiment, MRM transitions are then added to and removed from a list of transitions to be executed during each cycle of the tandem mass spectrometer based on their retention time or retention time range. In this way, the number of transitions being executed during any one cycle is reduced.

Unfortunately, however, in some instances, compounds of interest may not separate from a sample at the retention times specified in a scheduled MRM experiment. For example, the scheduled MRM experiment may be performed by a different laboratory or under different experimental conditions. In addition, scheduled MRM is dependent on the accuracy and absolute value of the retention time used for each transition. Whenever the separation device changes or the gradient of separation changes, the retention time for each transition must be recomputed. This becomes particularly cumbersome when workflows include thousands of MRM transitions. This also makes it difficult to use scheduled MRM workflows across separation devices produced by different manufacturers that have different elution rates.

As a result, a method for triggering MRM transitions that is not based on retention time was developed. In this method, a scout or sentinel MRM transition is used to trigger a group of additional MRM transitions to be analyzed. More specifically, the MRM transitions of an experiment for a sample are divided into two or more contiguous groups of MRM transitions so that the groups are executed sequentially. Each group includes at least one scout or sentinel MRM transition that identifies the next group of MRM transitions to be executed.

During acquisition, a first group of MRM transitions is selected for monitoring. When at least one sentinel MS/MS scan in the first group is detected by the tandem mass spectrometer, the next group of MRM transitions identified by the at least one sentinel MS/MS scan is added to the list of transitions monitored by the tandem mass spectrometer. In other words, at least one sentinel MS/MS scan in each group is used to trigger the transitions in the next contiguous group.

A group of MRM transitions can also be removed from monitoring. For example, once at least one sentinel MS/MS scan in the next contiguous group is detected, the transitions in the first group can be removed from monitoring.

As a result, by using sentinel transitions to trigger the inclusion and removal of MRM transitions from monitoring, the overall number of MRM transitions being monitored at any one time is reduced. In addition, because the groups of transitions are not dependent on a specific retention time, workflows based on these systems and methods can be used without modification whenever the separation device changes or the gradient of separation changes.

U.S. Pat. No. 10,566,178 (hereinafter the “'178 Patent”), incorporated herein by reference, describes using sentinel transitions to overcome the limitations of scheduled MRM. The '178 Patent describes systems and methods in which sentinel transitions are used in conjunction with a system that includes a separation device, such as LC, for separating compounds from a sample.

U.S. Pat. No. 11,024,495 (hereinafter the “'495 Patent”), incorporated herein by reference, was a continuation application of '178 Patent and describes systems and methods in which sentinel transitions are used without a separation device. The '495 Patent essentially describes systems and methods in which sentinel transitions are used in conjunction with any method of introducing compounds of interest into a tandem mass spectrometer.

One exemplary method of introducing compounds of interest into a tandem mass spectrometer without a separation device is through the use of a sample introduction device. U.S. patent application Ser. No. 17/999,569 (hereinafter the “'569 Application”), incorporated herein by reference, describes systems and methods in which scout or sentinel transitions are used in conjunction with a sample introduction device that ejects samples at an ejection time and according to a sample order. An exemplary sample introduction device that ejects samples at an ejection time and according to a sample order is an acoustic droplet ejection (ADE) device that delivers samples rapidly to an open port interface (OPI) from individual microtiter plate wells.

MRM experiments are typically performed using “low resolution” instruments that include, but are not limited to, triple quadrupole (QqQ) or quadrupole linear ion trap (QqLIT) devices. With the advent of “high resolution” instruments, there was a desire to collect MS and MS/MS using workflows that are similar to QqQ/QqLIT systems. High resolution instruments include, but are not limited to, quadrupole time-of-flight (QqTOF) or orbitrap devices. These high resolution instruments also provide new functionality.

MRM on QqQ/QqLIT systems is the standard mass spectrometric technique of choice for targeted quantification in all application areas, due to its ability to provide the highest specificity and sensitivity for the detection of specific components in complex mixtures. However, the speed and sensitivity of today's accurate mass systems have enabled a new quantification strategy with similar performance characteristics. In this strategy (termed MRM high resolution (MRM-HR) or parallel reaction monitoring (PRM)), looped MS/MS spectra are collected at high-resolution with short accumulation times, and then fragment ions (product ions) are extracted post-acquisition to generate MRM-like peaks for integration and quantification. With instrumentation like the TRIPLETOF® Systems of AB SCIEX™, this targeted technique is sensitive and fast enough to enable quantitative performance similar to higher end triple quadrupole instruments, with full fragmentation data measured at high resolution and high mass accuracy.

In other words, in methods such as MRM-HR, a high-resolution precursor ion mass spectrum is obtained, one or more precursor ions are selected and fragmented, and a high-resolution full product ion spectrum is obtained for each selected precursor ion. A full product ion spectrum is collected for each selected precursor ion but a product ion mass of interest can be specified and everything other than the mass window of the product ion mass of interest can be discarded.

International Patent Application Number WO 2022/074610 (hereinafter the “'610 Application”), incorporated herein by reference, describes systems and methods to trigger the next group of MS/MS scans to be executed by a high-resolution tandem mass spectrometer based on detection of a sentinel ion during an MS scan.

### Mass Spectrometry Background

Mass spectrometers are often coupled with separation devices, such as chromatography devices, or sample introduction systems, such as an ADE device and OPI, in order to identify and characterize compounds of interest from a sample or to analyze multiple samples. In such a coupled system, the eluting or injected solvent is ionized and a series of mass spectra are obtained from the eluting solvent at specified time intervals called retention times. These retention times range from, for example, 1 second to 100 minutes or greater. The series of mass spectra form a chromatogram, or extracted ion chromatogram (XIC).

Peaks found in the XIC are used to identify or characterize a known peptide or compound in a sample, for example. More particularly, the retention times of peaks and/or the area of peaks are used to identify or characterize (quantify) a known peptide or compound in the sample. In the case of multiple samples provided over time by a sample introduction device, the retention times of peaks are used to align the peaks with the correct sample.

In traditional separation coupled mass spectrometry systems, a fragment or product ion of a known compound is selected for analysis. A tandem mass spectrometry or mass spectrometry/mass spectrometry (MS/MS) scan is then performed at each interval of the separation for a mass range that includes the product ion. The intensity of the product ion found in each MS/MS scan is collected over time and analyzed as a collection of spectra, or an XIC, for example.

In general, tandem mass spectrometry, or MS/MS, is a well-known technique for analyzing compounds. Tandem mass spectrometry involves ionization of one or more compounds from a sample, selection of one or more precursor ions of the one or more compounds, fragmentation of the one or more precursor ions into fragment or product ions, and mass analysis of the product ions.

Tandem mass spectrometry can provide both qualitative and quantitative information. The product ion spectrum can be used to identify a molecule of interest. The intensity of one or more product ions can be used to quantitate the amount of the compound present in a sample.

A large number of different types of experimental methods or workflows can be performed using a tandem mass spectrometer. Three broad categories of these workflows are targeted acquisition, information dependent acquisition (IDA) or data-dependent acquisition (DDA), and data-independent acquisition (DIA).

In a targeted acquisition method, one or more transitions of a precursor ion to a product ion are predefined for a compound of interest. As a sample is being introduced into the tandem mass spectrometer, the one or more transitions are interrogated or monitored during each time period or cycle of a plurality of time periods or cycles. In other words, the mass spectrometer selects and fragments the precursor ion of each transition and performs a targeted mass analysis only for the product ion of the transition. As a result, an intensity (a product ion intensity) is produced for each transition. Targeted acquisition methods include, but are not limited to, multiple reaction monitoring (MRM) and selected reaction monitoring (SRM).

In a targeted acquisition method, a list of transitions is typically interrogated during each cycle time. In order to decrease the number of transitions that are interrogated at any one time, some targeted acquisition methods have been modified to include a retention time or a retention time range for each transition. Only at that retention time or within that retention time range will that particular transition be interrogated. One targeted acquisition method that allows retention times to be specified with transitions is referred to as scheduled MRM.

In an IDA method, a user can specify criteria for performing an untargeted mass analysis of product ions, while a sample is being introduced into the tandem mass spectrometer. For example, in an IDA method, a precursor ion or mass spectrometry (MS) survey scan is performed to generate a precursor ion peak list. The user can select criteria to filter the peak list for a subset of the precursor ions on the peak list. MS/MS is then performed on each precursor ion of the subset of precursor ions. A product ion spectrum is produced for each precursor ion.

MS/MS is repeatedly performed on the precursor ions of the subset of precursor ions as the sample is being introduced into the tandem mass spectrometer.

In proteomics and for many other sample types, however, the complexity and dynamic range of compounds are very large. This poses challenges for traditional targeted and IDA methods, requiring very high-speed MS/MS acquisition to deeply interrogate the sample in order to both identify and quantify a broad range of analytes.

As a result, DIA methods, the third broad category of tandem mass spectrometry, were developed. These DIA methods have been used to increase the reproducibility and comprehensiveness of data collection from complex samples. DIA methods can also be called non-specific fragmentation methods. In a traditional DIA method, the actions of the tandem mass spectrometer are not varied among MS/MS scans based on data acquired in a previous precursor or product ion scan. Instead, a precursor ion mass range is selected. A precursor ion mass selection window is then stepped across the precursor ion mass range. All precursor ions in the precursor ion mass selection window are fragmented and all of the product ions of all of the precursor ions in the precursor ion mass selection window are mass analyzed.

The precursor ion mass selection window used to scan the mass range can be very narrow so that the likelihood of multiple precursors within the window is small. This type of DIA method is called, for example, MS/MS^{ALL}. In an MS/MS^{ALL} method, a precursor ion mass selection window of about 1 amu is scanned or stepped across an entire mass range. A product ion spectrum is produced for each 1 amu precursor mass window. The time it takes to analyze or scan the entire mass range once is referred to as one scan cycle. Scanning a narrow precursor ion mass selection window across a wide precursor ion mass range during each cycle, however, is not practical for some instruments and experiments.

As a result, a larger precursor ion mass selection window, or selection window with a greater width, is stepped across the entire precursor mass range. This type of DIA method is called, for example, SWATH acquisition. In a SWATH acquisition, the precursor ion mass selection window stepped across the precursor mass range in each cycle may have a width of 5 -25 amu, or even larger. Like the MS/MS^{ALL} method, all the precursor ions in each precursor ion mass selection window are fragmented, and all of the product ions of all of the precursor ions in each mass selection window are mass analyzed.

### SUMMARY

A system, method, and computer program product are provided for correcting a measured retention time or expected retention time of an ion intensity measurement. The system includes a processor.

The processor receives a measured sentinel retention time for each of a plurality of sentinel ion intensity measurements. During acquisition, sentinel analysis is performed. In sentinel analysis, a plurality of ion intensity measurements is divided into two or more groups so that different groups of the two or more groups are measured separately. At least one sentinel ion intensity measurement in each group of the two or more groups is selected to identify a next group of the two or more groups to be measured.

The processor corrects a measured retention time or an expected retention time of at least one non-sentinel ion intensity measurement of the two or more groups using the plurality of measured sentinel retention times.

In one general aspect, a method for correcting a measured retention time or expected retention time of an ion intensity measurement can include: (a) receiving a measured sentinel retention time for each of a plurality of sentinel ion intensity measurements, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and (b) correcting a measured retention time or an expected retention time of at least one non-sentinel ion intensity measurement of the two or more groups using the plurality of measured sentinel retention times.

In some embodiments, the correcting the measured retention time or the expected retention time of the at least one non-sentinel ion intensity measurement can include, for each sample of a subset of samples of a plurality of samples of an experiment, comparing the plurality of measured sentinel retention times of the each sample to a plurality of reference sentinel retention times, calculating a sample correction function based on the comparison, and combining the one or more sample correction functions to produce a correction function.

In some embodiments, the combining the one or more sample correction functions can include averaging the one or more sample correction functions.

In some embodiments, the correcting the measured retention time or the expected retention time of the at least one non-sentinel ion intensity measurement of the two or more groups can include correcting an expected retention time of the at least one non-sentinel ion intensity measurement using the correction function.

In some embodiments, the correcting the measured retention time or the expected retention time of the at least one non-sentinel ion intensity measurement can include correcting a measured retention time of the at least one non-sentinel ion intensity measurement using the correction function.

In some embodiments, the correcting the measured retention time or the expected retention time of the at least one non-sentinel ion intensity measurement can include, for each sample of a plurality of samples of an experiment, comparing the plurality of measured sentinel retention times of the each sample to a plurality of reference sentinel retention times and calculating a sample correction function based on the comparison, producing a sample correction function for each sample of the plurality of samples.

In some embodiments, the correcting the measured retention time or the expected retention time of the at least one non-sentinel ion intensity measurement of the two or more groups can include correcting an expected retention time of the at least one non-sentinel ion intensity measurement of a sample using a sample correction function of the sample.

In some embodiments, the correcting the measured retention time or the expected retention time of the least one non-sentinel ion intensity measurement can include correcting a measured retention time of the at least one non-sentinel ion intensity measurement of a sample using a sample correction function of the sample.

In some embodiments, each sample correction function of the one or more sample correction functions can be linear and the correction function can be linear.

In some embodiments, each sample correction function of the one or more sample correction functions can be piecewise linear and the correction function can be piecewise linear.

In some embodiments, each sample correction function for each sample of the plurality of samples can be linear.

In some embodiments, each sample correction function for each sample of the plurality of samples can be piecewise linear.

In some embodiments, the plurality of sentinel ion intensity measurements can include multiple reaction monitoring (MRM) transition measurements or mass spectrometry/mass spectrometry (MSMS) product ion measurements and the at least one non-sentinel ion intensity measurement can include an MRM transition measurement or an MSMS product ion measurement.

In another general aspect, a computer program product can include a non-transitory tangible computer-readable storage medium whose contents cause a processor to perform a method for correcting a measured retention time or expected retention time of an ion intensity measurement. The method can include: (a) providing a system, wherein the system comprises one or more distinct software modules, and wherein the distinct software modules comprise an input module and an analysis module; (b) receiving a measured sentinel retention time for each of a plurality of sentinel ion intensity measurements using the input module, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and (c) correcting a measured retention time or an expected retention time of at least one non-sentinel ion intensity measurement of the two or more groups using the plurality of measured sentinel retention times using the analysis module.

In another general aspect, a system for correcting a measured retention time or expected retention time of an ion intensity measurement can include a processor that: (a) receives a measured sentinel retention time for each of a plurality of sentinel ion intensity measurements, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and (b) corrects a measured retention time or an expected retention time of at least one non-sentinel ion intensity measurement of the two or more groups using the plurality of measured sentinel retention times.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary diagram of a user interface from a peak integration program showing the reliance of the program on an expected retention time and a retention time window provided by a user.

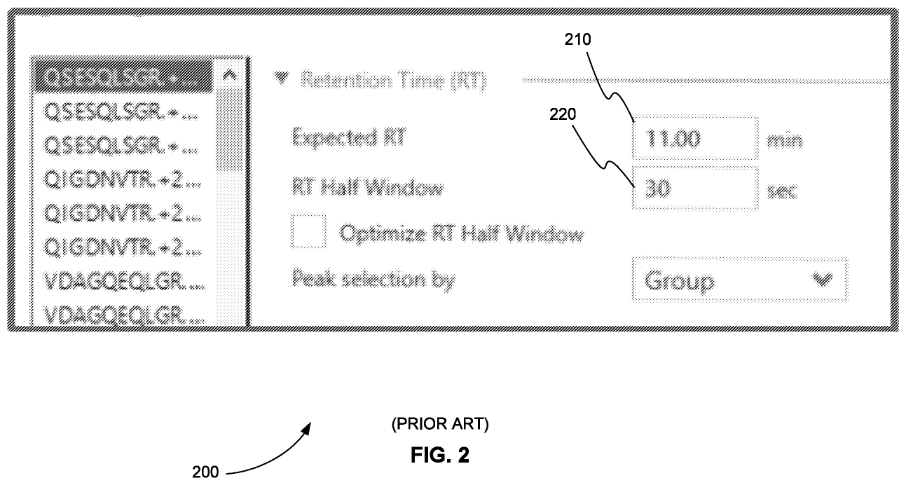

FIG. 3 is an exemplary plot showing the correlation between measured retention times and expected retention times of seven sentinels, in accordance with various embodiments.

FIG. 4 is an exemplary plot showing the retention times of the expected extracted ion chromatogram (XIC) peaks of four different sentinels, in accordance with various embodiments.

FIG. 5 is an exemplary table listing the retention times of the expected XIC peaks of the four different sentinels of FIG. 4, in accordance with various embodiments.

FIG. 6 is an exemplary plot showing the retention times of the measured XIC peaks of the same four different sentinels of FIG. 4 after a change in the chromatography conditions, in accordance with various embodiments.

FIG. 7 is an exemplary table listing the retention times of the measured XIC peaks of the four different sentinels of FIG. 6, in accordance with various embodiments.

FIG. 8 is an exemplary plot showing the correlation between the measured or current retention times of FIG. 7 and the expected, reference, or original retention times of FIG. 5 for the four sentinels of FIGS. 5 and 7, in accordance with various embodiments.

FIG. 9 is an exemplary table listing the retention times of the measured or current XIC peaks, the original or reference XIC peaks, and the new original or reference XIC peaks calculated from the correction function of FIG. 8 for the four different sentinels of FIG. 4, in accordance with various embodiments.

FIG. 10 is an exemplary plot showing new corrected retention times for the original or reference XIC peaks in relation to the previous retention times for the original or reference XIC peaks and the retention times for the current or measured XIC peaks of four different sentinels, in accordance with various embodiments.

FIG. 11 is an exemplary plot showing how shifting the retention time of an original or reference XIC peak allows narrower tolerances for peak integration, in accordance with various embodiments.

FIG. 12 is an exemplary series of plots showing how a correction function is used to adjust or shift the retention times of the current or measured XIC peaks, in accordance with various embodiments.

FIG. 13 is a schematic diagram of a system for correcting a measured retention time or expected retention time of an ion intensity measurement, in accordance with various embodiments.

FIG. 14 is a flowchart showing a method for correcting a measured retention time or expected retention time of an ion intensity measurement, in accordance with various embodiments.

FIG. 15 is a schematic diagram of a system that includes one or more distinct software modules that performs a method for correcting a measured retention time or expected retention time of an ion intensity measurement, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

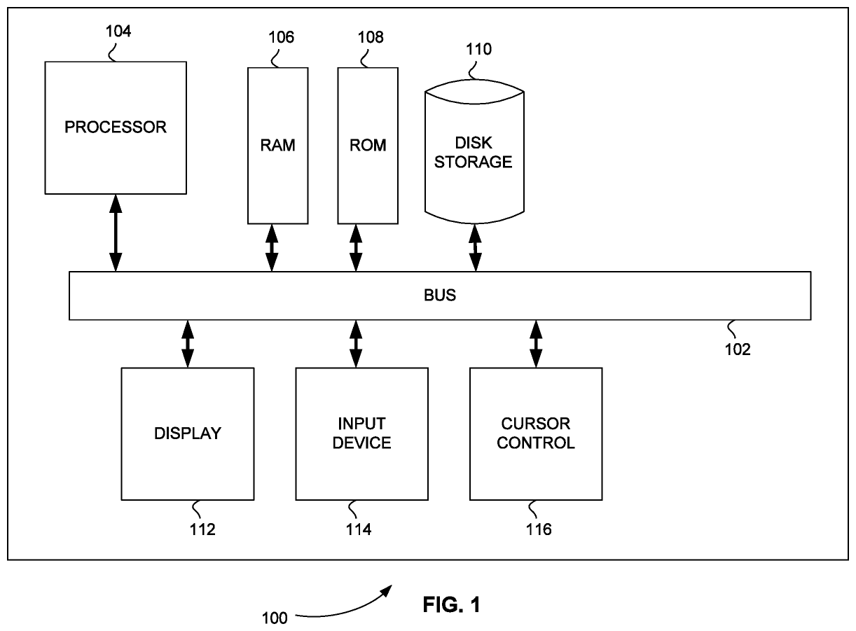

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus, implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### RETENTION TIME CORRECTION

As described above, there is a need for systems and methods to correct a measured retention time or an expected retention time of an ion intensity measurement when using sentinels in data collection.

In various embodiments, sentinels are used to correct for any retention time drift that occurs during data collection and to propagate the correction to a data processing step.

In various embodiments, the measured retention times of the sentinels are compared to the expected retention times of the sentinels. A correction based on this comparison is then propagated to all of the data.

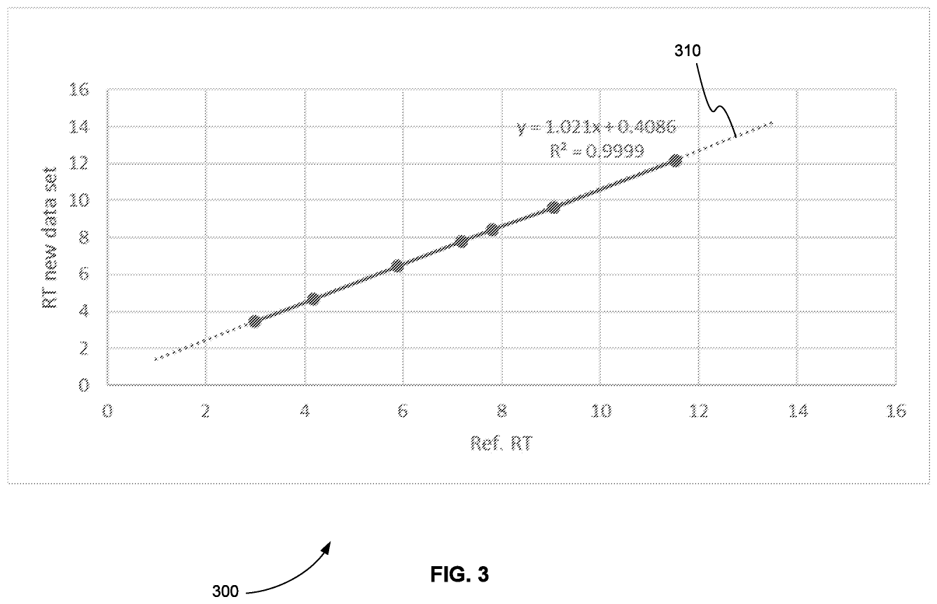

FIG. 3 is an exemplary plot 300 showing the correlation between measured retention times and expected retention times of seven sentinels, in accordance with various embodiments. Plot 300 shows the measured retention times (y-axis) versus the expected retention times (x-axis). A linear correction function 310, for example, can be obtained from plot 300. This correction function can then be used to adjust all other data points of the experiment. This adjustment allows the same peak integration method with a narrow tolerance for both the expected-RT and the RT-window that is used for the reference or expected data to be used for the measured data.

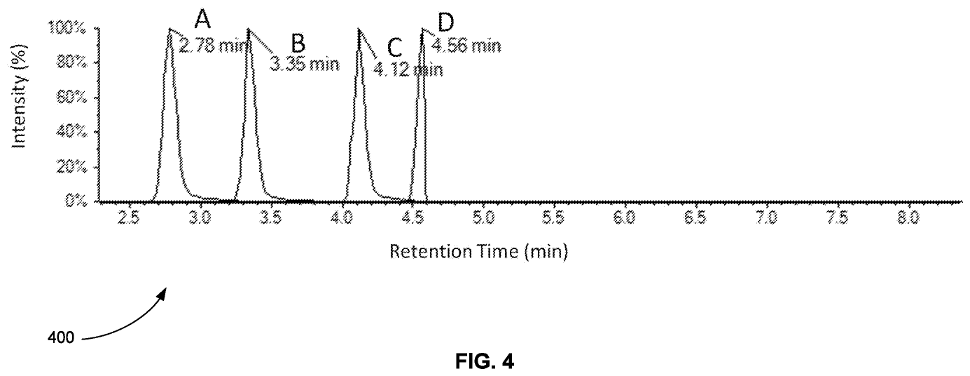

FIG. 4 is an exemplary plot 400 showing the retention times of the expected extracted ion chromatogram (XIC) peaks of four different sentinels, in accordance with various embodiments. The XIC peaks of plot 400 are from a reference, original, or previous experiment, for example. The XIC peaks of other expected compounds of interest are not shown.

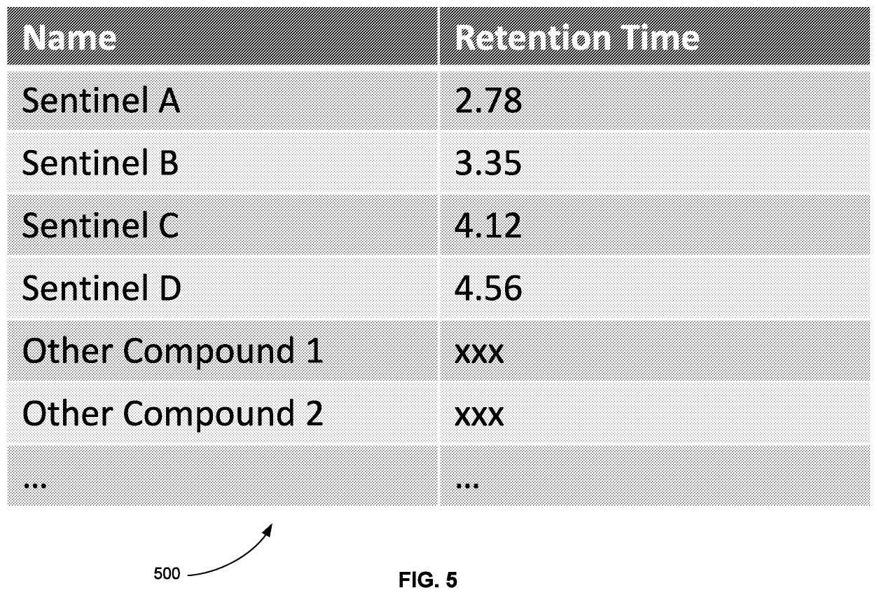

FIG. 5 is an exemplary table 500 listing the retention times of the expected XIC peaks of the four different sentinels of FIG. 4, in accordance with various embodiments. Table 5 shows that such a listing can also include other expected compounds of interest.

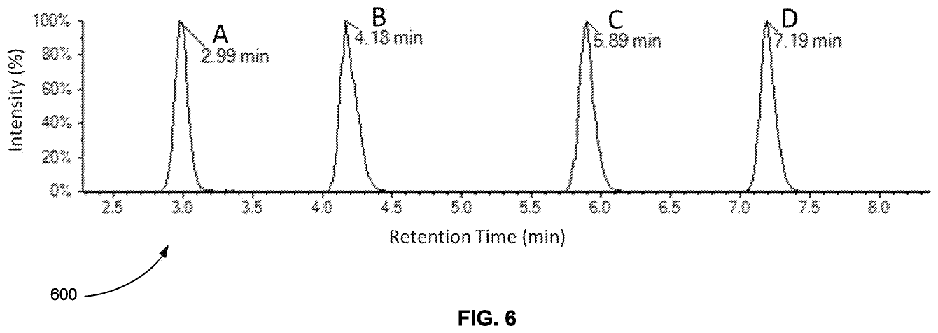

FIG. 6 is an exemplary plot 600 showing the retention times of the measured XIC peaks of the same four different sentinels of FIG. 4 after a change in the chromatography conditions, in accordance with various embodiments. The change in the chromatography conditions may have occurred between an expected or reference experiment and a current measured experiment or between an original or previous experiment and a current measured experiment.

In comparison to FIG. 4, the retention times of the four different sentinels in FIG. 6 have shifted. This shows that the sentinels experience the same type of shifts as the compounds of interest due to a change in the chromatography conditions. As described above, these shifts can cause issues in processing the data collected for compounds of interest. These issues are not typically experienced in processing the data collected for sentinels due to their larger intensity. They are also typically selected to explicitly avoid interferences. As a result, in various embodiments, the retention time shifts observed in the sentinels can be used to correct the retention times of the compounds of interest.

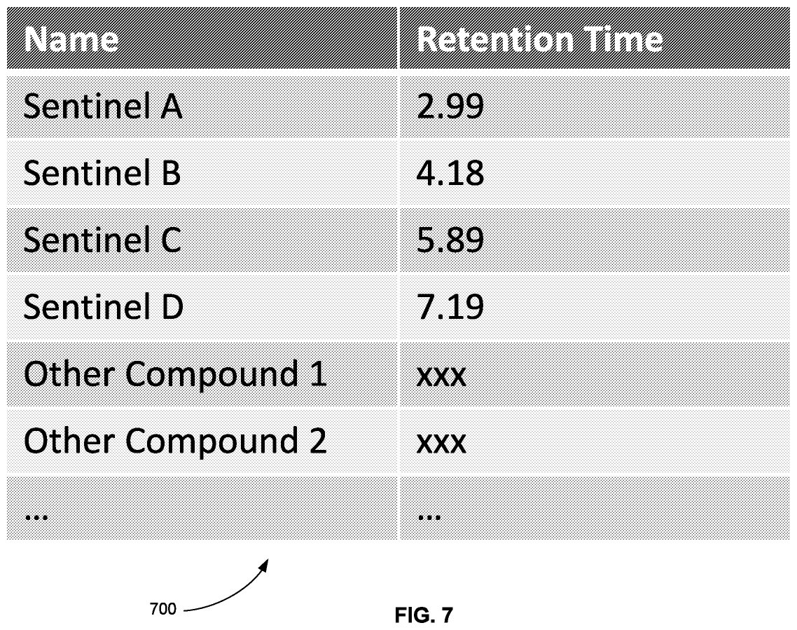

FIG. 7 is an exemplary table 700 listing the retention times of the measured XIC peaks of the four different sentinels of FIG. 6, in accordance with various embodiments. Table 7 again shows that such a listing can also include other expected compounds of interest. Using the sentinel retention times of FIGS. 5 and 7, a correction function can be found.

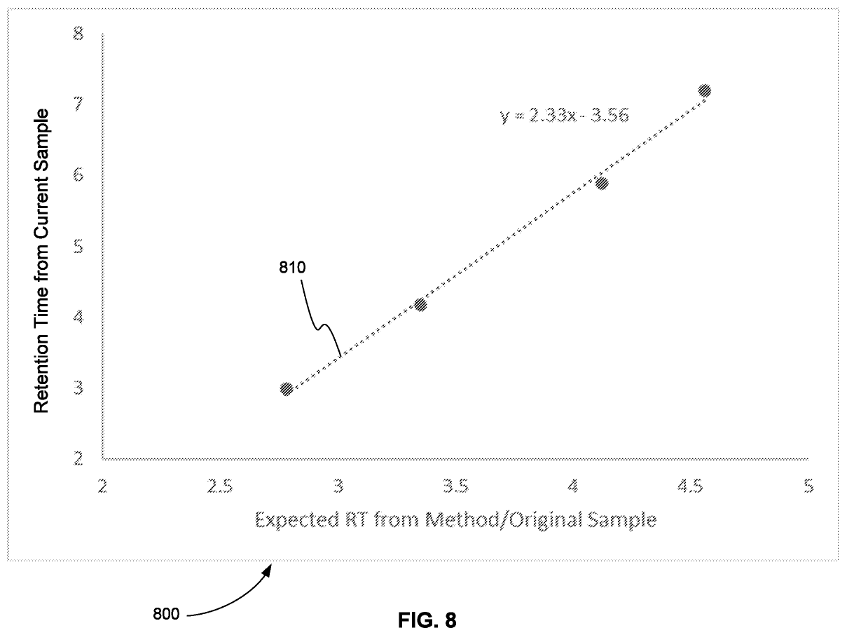

FIG. 8 is an exemplary plot 800 showing the correlation between the measured or current retention times of FIG. 7 and the expected, reference, or original retention times of FIG. 5 for the four sentinels of FIGS. 5 and 7, in accordance with various embodiments. A linear correction function 810, for example, can be obtained from plot 800. Correction function 810 can then be used to adjust other data points. Correction function 810 is, for example, a linear function such as y=2.33x−3.56 as here.

In various embodiments, correction function 810 can be used to adjust or shift the retention times of expected, reference, or original retention times of compounds of interest or the retention times of measured or new retention times of compounds of interest before additional processing such as peak integration.

### Shifting Expected Retention Times

In various embodiments, correction function 810 of FIG. 8 is used to adjust or shift the retention times of expected, reference, or original retention times of compounds of interest. This produces “new” or corrected expected, reference, or original retention times.

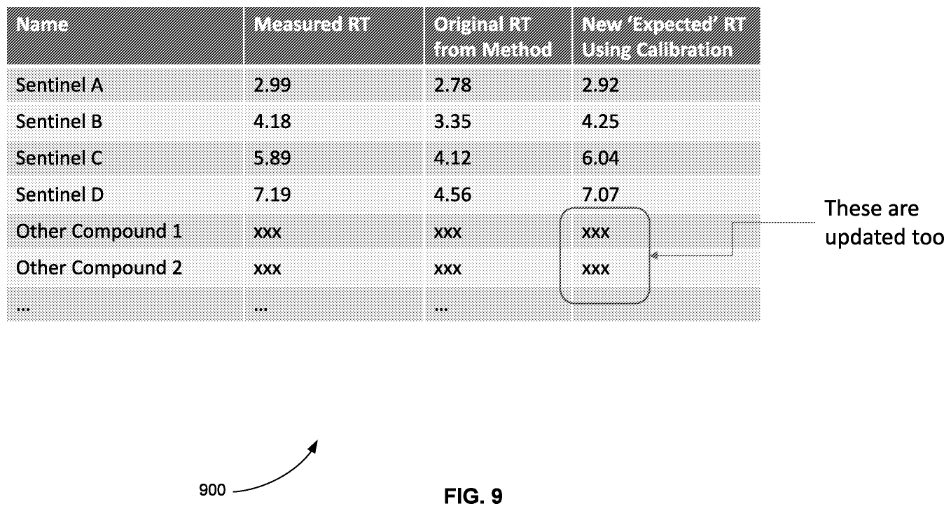

FIG. 9 is an exemplary table 900 listing the retention times of the measured or current XIC peaks, the original or reference XIC peaks, and the new original or reference XIC peaks calculated from the correction function of FIG. 8 for the four different sentinels of FIG. 4, in accordance with various embodiments. The retention times of the new XIC peaks calculated from the correction function of FIG. 8 for the four different sentinels of FIG. 4 are new shifted retention times for the original or reference XIC peaks of the sentinels of FIG. 4. Similarly, the retention times of the original or reference XIC peaks of other compounds of interest are also shifted using the correction function of FIG. 8.

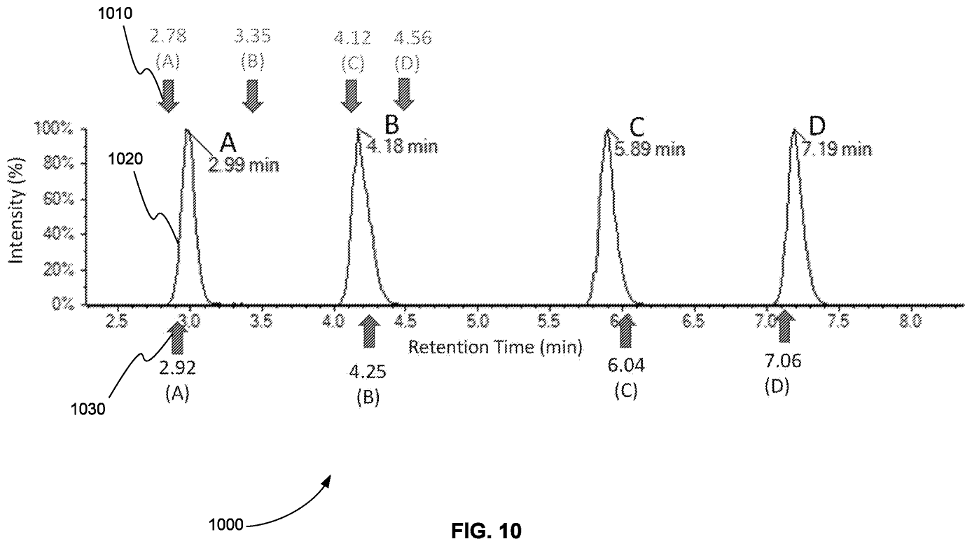

FIG. 10 is an exemplary plot 1000 showing new corrected retention times for the original or reference XIC peaks in relation to the previous retention times for the original or reference XIC peaks and the retention times for the current or measured XIC peaks of four different sentinels, in accordance with various embodiments. Arrows 1010 show the position of the previous retention times for the original or reference XIC peaks of the four sentinels. XIC peaks 1020 show the position of the retention times for the measured or current XIC peaks of the four sentinels. Arrows 1030 show the position of the new corrected retention times for the original or reference XIC peaks of the four sentinels.

In this embodiment, like in FIG. 10, the retention times of the original or reference XIC peaks for all compounds of interest are shifted rather than the currently measured retention times. As a result, the new corrected retention times for the original or reference XIC peaks of all compounds of interest and the retention times for the measured or current XIC peaks of all compounds of interest are used for additional processing, such as peak integration. This allows a corrected “expected RT” and narrow tolerances for “RT-window” when performing peak integration.

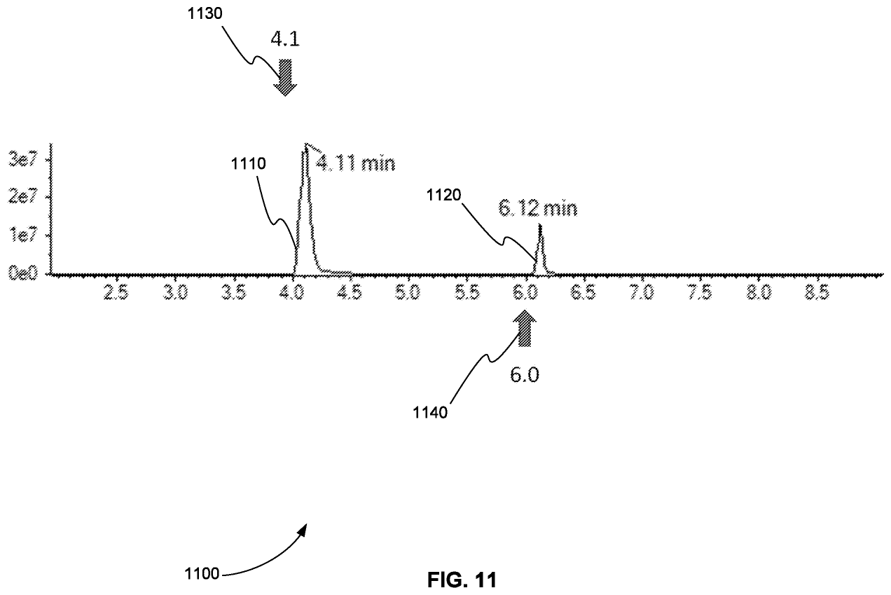

FIG. 11 is an exemplary plot 1100 showing how shifting the retention time of an original or reference XIC peak allows narrower tolerances for peak integration, in accordance with various embodiments. In plot 1100, XIC peak 1110 is an interference and XIC peak 1120 is a compound of interest. Arrow 1130 shows the position of the retention time for the original or reference XIC peak of the compound of interest.

Due to changes in the chromatography conditions, for example, the position of the retention time, 4.1 minutes, for the original or reference XIC peak of the compound of interest (arrow 1130) is closer to interference XIC peak 1110 than to compound of interest XIC peak 1120. Without retention time correction, a very large retention time window half width (more than 2.0 minutes) would need to be used to have a chance of finding compound of interest XIC peak 1120. This would still be challenging since interference XIC peak 1110 is much closer to the original expected retention time and larger than compound of interest XIC peak 1120.

Arrow 1140, however, shows the newly adjusted position of the retention time, 6.0 minutes, for the original or reference XIC peak of the compound of interest after correction function 810 of FIG. 8 is applied, for example.

Applying correction function 810 to the reference retention time of 4.1 minutes, 2.33×4.1−3.56=6.00, the corrected retention time is approximately 6.0 minutes. Returning to FIG. 11, after correction, a much narrower retention time window half-width can be used (something a bit more than 0.12 minutes), and, when the retention time window is centered at the new expected retention time of 6.0 minutes, the window only includes compound of interest XIC peak 1120 and not interference XIC peak 1110. In other words, the retention time correction has both found the correct peak and excluded an interference.

In various embodiments, retention time correction is applied once in each experiment, which can contain a plurality of samples. This, however, assumes that a compound of interest has the same retention in different samples in the experiment (but a different retention time in the original or reference sample). In other words, the retention time for any given analyte or compound is assumed to be similar for the different samples. The retention time correction is then performed only for one sample of the experiment.

In various embodiments, retention time correction is applied for each sample of an experiment, which can contain a plurality of samples. In this case, a correction function is calculated for each sample. This embodiment requires more calculations but has the advantage that it also compensates for (the smaller) retention time variations within an experiment, not just between the original or reference sample and the “average” sample of an experiment.

### Shifting Measured Retention Times

Returning to FIG. 8, in various embodiments, correction function 810 is used to adjust or shift the retention times of the current or measured retention times of compounds of interest. This produces “new” or corrected measured retention times.

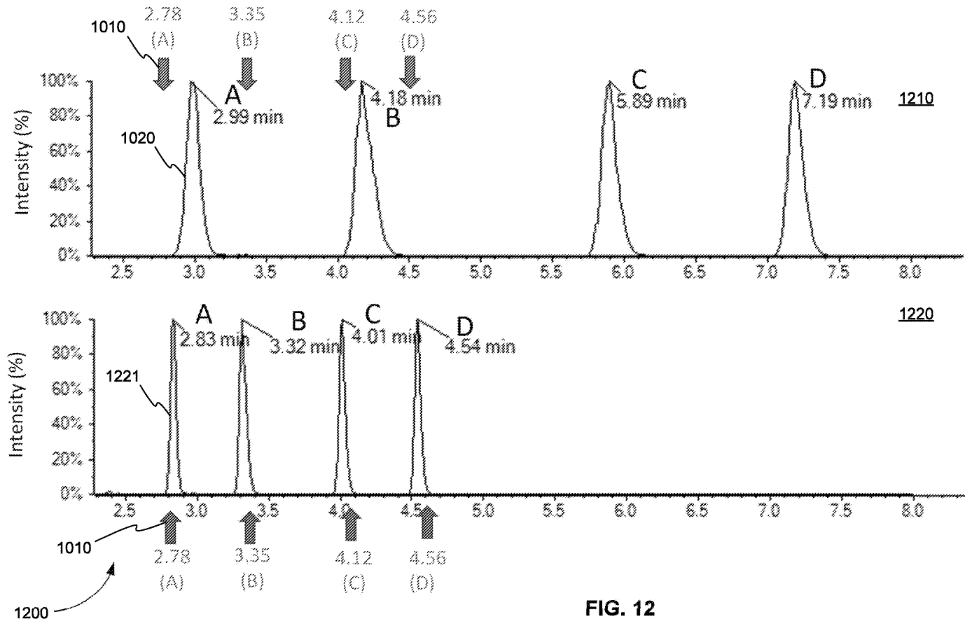

FIG. 12 is an exemplary series 1200 of plots, including plots 1210 and 1220, showing how a correction function is used to adjust or shift the retention times of the current or measured XIC peaks, in accordance with various embodiments. In plot 1210, arrows 1010 show the position of the previous retention times for the original or reference XIC peaks of the four sentinels. XIC peaks 1020 show the position of the retention times for the measured or current XIC peaks of the four sentinels. The correction function is applied to the retention times for the measured or current XIC peaks 1020.

In plot 1220, XIC peaks 1221 show the position of the new corrected retention times for the measured or current XIC peaks of the four sentinels. In other words, using correction function 810 of FIG. 8, XIC peaks 1020 of plot 1210 are shifted to become XIC peaks 1221 of plot 1220. Arrows 1010 of plot 1220 show that the corrected retention times of XIC peaks 1221 are close to the original or reference XIC peaks of the four sentinels. They are not exactly the same because the linear regression is not perfect.

In this embodiment, like in FIG. 12, the retention times of measured XIC peaks for all compounds of interest are shifted rather than the original or reference retention times. As a result, the new corrected retention times for the measured XIC peaks of all compounds of interest and the retention times for original or reference XIC peaks of all compounds of interest are used for additional processing, such as peak integration. This allows narrow tolerances for the “RT-window” when performing peak integration.

In various embodiments, retention time correction is applied once in each experiment, which can contain a plurality of samples. This, however, assumes that a compound of interest has the same retention in different samples in the experiment (but a different retention time in the original or reference sample). In other words, the retention time for any given analyte or compound is assumed to be similar for the different samples. The retention time correction is then performed only for one sample of the experiment.

In various embodiments, retention time correction is applied for each sample of an experiment, which can contain a plurality of samples. In this case, a correction function is calculated for each sample. This embodiment requires more calculations but has the advantage that it also compensates for (the smaller) retention time variations within an experiment, not just between the original or reference sample and the “average” sample of an experiment.

### System for Correcting a Retention Time

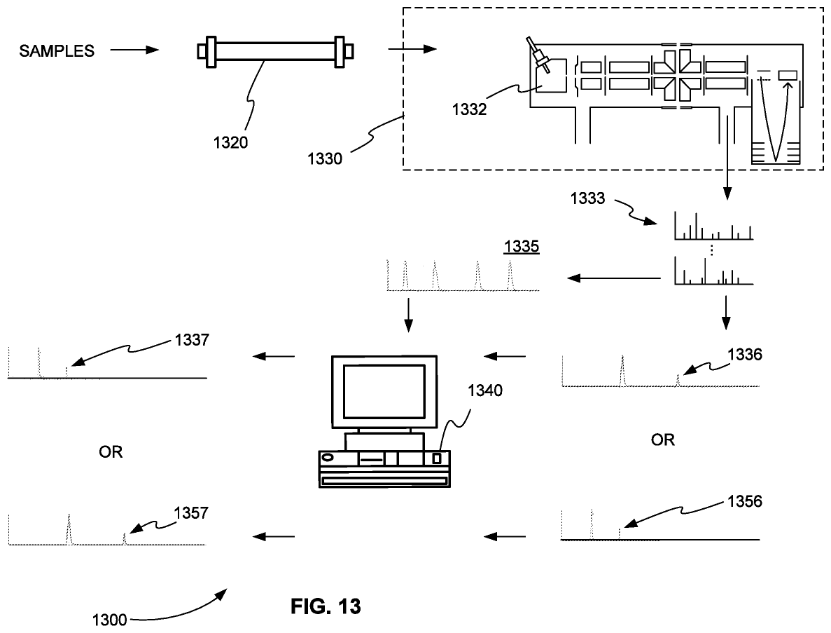

FIG. 13 is a schematic diagram 1300 of a system for correcting a measured retention time or expected retention time of an ion intensity measurement, in accordance with various embodiments. The system includes processor 1340. Processor 1340 can be, but is not limited to, a controller, a computer, a microprocessor, the computer system of FIG. 1, or any device capable of analyzing data. Processor 1340 can also be any device capable of sending and receiving control signals and data.

Processor 1340 receives a measured sentinel retention time for each of a plurality of sentinel ion intensity measurements 1335. During acquisition, sentinel analysis is performed. In sentinel analysis, a plurality of ion intensity measurements is divided into two or more groups so that different groups of the two or more groups are measured separately. At least one sentinel ion intensity measurement in each group of the two or more groups is selected to identify a next group of the two or more groups to be measured.

Processor 1340 corrects a measured retention time 1336 or an expected retention time 1356 of at least one non-sentinel ion intensity measurement of the two or more groups using plurality of measured sentinel retention times 1335.

In various embodiments, processor 1340 calculates a correction function using plurality of measured sentinel retention times 1335.

In various embodiments, a single correction function is calculated from a subset of samples of a plurality of samples of an experiment and then applied to all samples. For example, a correction function is calculated by comparing the plurality of measured sentinel retention times of each sample of the subset to a plurality of reference sentinel retention times, calculating a sample correction function based on the comparison, and combining the one or more sample correction functions to produce the correction function.

In various embodiments, combining the one or more sample correction functions includes averaging the one or more sample correction functions.

In various embodiments, each sample correction function of the one or more sample correction functions is linear and the correction function is linear.

In various embodiments, each sample correction function of the one or more sample correction functions is piecewise linear and the correction function is piecewise linear.

In various embodiments, expected retention time 1356 of the at least one non-sentinel ion intensity measurement is corrected using the correction function. Corrected expected retention time 1357 is produced.

In various embodiments, measured retention time 1336 of the at least one non-sentinel ion intensity measurement is corrected using the correction function. Corrected measured retention time 1337 is produced.

In various embodiments, a correction function is calculated for each sample of a plurality of samples of an experiment and is only applied to that sample. For example, a sample correction function is produced for each sample of the plurality of samples by comparing the plurality of measured sentinel retention times of each sample to a plurality of reference sentinel retention times and calculating a sample correction function based on the comparison.

In various embodiments, each sample correction function for each sample of the plurality of samples is linear.

In various embodiments, each sample correction function for each sample of the plurality of samples is piecewise linear.

In various embodiments, expected retention time 1356 of the at least one non-sentinel ion intensity measurement of a sample is corrected using a sample correction function of the sample.

In various embodiments, measured retention time 1356 of the at least one non-sentinel ion intensity measurement of a sample is corrected using a sample correction function of the sample.

In various embodiments, the plurality of sentinel ion intensity measurements includes MRM transition measurements or MSMS product ion measurements and the at least one non-sentinel ion intensity measurement includes an MRM transition measurement or an MSMS product ion measurement.

In various embodiments, the system of FIG. 13 further includes mass spectrometer 1330. Ion source device 1332 of mass spectrometer 1330 ionizes one or more samples, producing an ion beam. Ion source device 1332 is controlled by processor 1340, for example. Ion source device 1332 is shown as a component of mass spectrometer 1330. In various alternative embodiments, ion source device 1332 is a separate device. Ion source device 1332 can be, but is not limited to, an electrospray ion source (ESI) device or a chemical ionization (CI) source device such as an atmospheric pressure chemical ionization source (APCI) device or an atmospheric pressure photoionization (APPI) source device.

Mass spectrometer 1330 selects and fragments compounds of interest and sentinels and mass analyzes resulting product ions from the ion beam. Mass spectrometer 1330 produces a plurality of product ion intensity measurements 1333 over time.

In various embodiments, the system of FIG. 13 further includes a separation device 1320 that separates compounds of interest and sentinels from a sample. As shown in FIG. 13, the additional device 1320 is an LC device. In various alternative embodiments, additional device 1320 can be, but is not limited to, a gas chromatography (GC) device, capillary electrophoresis (CE) device, or an ion mobility spectrometry (IMS) device.

### Method for Correcting a Retention Time

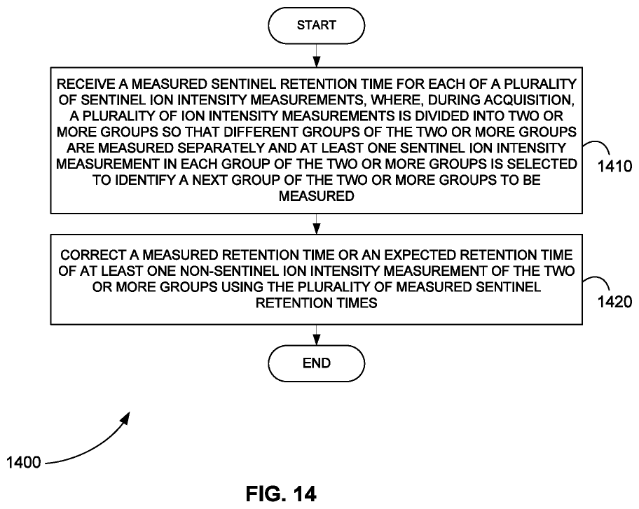

FIG. 14 is a flowchart showing a method 1400 for correcting a measured retention time or expected retention time of an ion intensity measurement, in accordance with various embodiments.

In step 1410 of method 1400, a measured sentinel retention time is received for each of a plurality of sentinel ion intensity measurements. During acquisition, sentinel analysis is performed. In sentinel analysis, a plurality of ion intensity measurements is divided into two or more groups so that different groups of the two or more groups are measured separately. At least one sentinel ion intensity measurement in each group of the two or more groups is selected to identify a next group of the two or more groups to be measured.

In step 1420, a measured retention time or an expected retention time of at least one non-sentinel ion intensity measurement of the two or more groups is corrected using the plurality of measured sentinel retention times.

### Computer Program Product for Correcting a Retention Time

In various embodiments, computer program products include a tangible computer-readable storage medium whose contents include a program with instructions being executed on a processor so as to perform a method for correcting a measured retention time or expected retention time of an ion intensity measurement. This method is performed by a system that includes one or more distinct software modules.

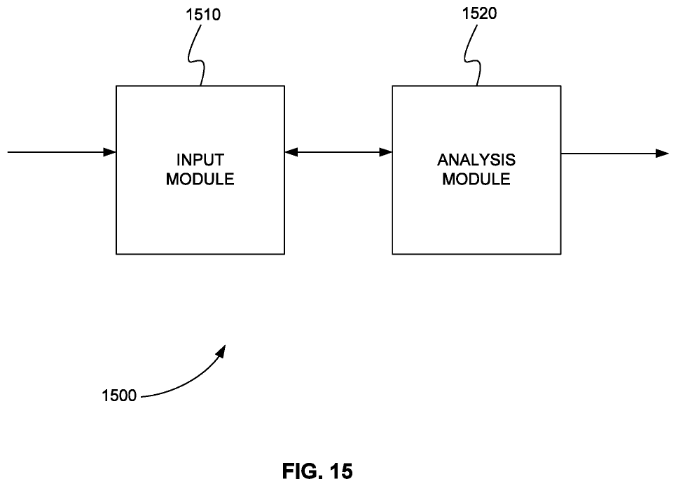

FIG. 15 is a schematic diagram of a system 1500 that includes one or more distinct software modules that perform a method for correcting a measured retention time or expected retention time of an ion intensity measurement, in accordance with various embodiments. System 1500 includes input module 1510 and analysis module 1520.

Input module 1510 receives a measured sentinel retention time for each of a plurality of sentinel ion intensity measurements. During acquisition, sentinel analysis is performed. In sentinel analysis, a plurality of ion intensity measurements is divided into two or more groups so that different groups of the two or more groups are measured separately. At least one sentinel ion intensity measurement in each group of the two or more groups is selected to identify a next group of the two or more groups to be measured.

Analysis module 1520 corrects a measured retention time or an expected retention time of at least one non-sentinel ion intensity measurement of the two or more groups using the plurality of measured sentinel retention times.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. Similarly, though the described application used MRM as a detection technique, the described method can be applied to any targeted analysis for MS/MS analysis such as MRM3, single ion monitoring (SIM) or even targeted product ion scan (TOF-MS). In addition, the claims directed to the method and/or process should not be limited to the performance of their steps in the order written, and one skilled in the art can readily appreciate that the sequences may be varied and still remain within the spirit and scope of the various embodiments.

1. A method for correcting a measured retention time or expected retention time of an ion intensity measurement, comprising:
(a) receiving a measured sentinel retention time for each of a plurality of sentinel ion intensity measurements, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and
(b) correcting a measured retention time or an expected retention time of at least one non-sentinel ion intensity measurement of the two or more groups using the plurality of measured sentinel retention times.

2. The method of claim 1, wherein the correcting the measured retention time or the expected retention time of the at least one non-sentinel ion intensity measurement comprises, for each sample of a subset of samples of a plurality of samples of an experiment, comparing the plurality of measured sentinel retention times of the each sample to a plurality of reference sentinel retention times, calculating a sample correction function based on the comparison, and combining the one or more sample correction functions to produce a correction function.

3. The method of claim 2, wherein the combining the one or more sample correction functions comprises averaging the one or more sample correction functions.

4. The method of claim 2, wherein the correcting the measured retention time or the expected retention time of the at least one non-sentinel ion intensity measurement of the two or more groups comprises correcting an expected retention time of the at least one non-sentinel ion intensity measurement using the correction function.

5. The method of claim 2 wherein the correcting the measured retention time or the expected retention time of the at least one non-sentinel ion intensity measurement comprises correcting a measured retention time of the at least one non-sentinel ion intensity measurement using the correction function.

6. The method of claim 1, wherein the correcting the measured retention time or the expected retention time of the at least one non-sentinel ion intensity measurement comprises, for each sample of a plurality of samples of an experiment, comparing the plurality of measured sentinel retention times of the each sample to a plurality of reference sentinel retention times and calculating a sample correction function based on the comparison, producing a sample correction function for each sample of the plurality of samples.

7. The method of claim 6, wherein the correcting the measured retention time or the expected retention time of the at least one non-sentinel ion intensity measurement of the two or more groups comprises correcting an expected retention time of the at least one non-sentinel ion intensity measurement of a sample using a sample correction function of the sample.

8. The method of claim 6, wherein the correcting the measured retention time or the expected retention time of the least one non-sentinel ion intensity measurement comprises correcting a measured retention time of the at least one non-sentinel ion intensity measurement of a sample using a sample correction function of the sample.

9. The method of claim 2, wherein each sample correction function of the one or more sample correction functions is linear and the correction function is linear.

10. The method of claim 2, wherein each sample correction function of the one or more sample correction functions is piecewise linear and the correction function is piecewise linear.

11. The method of claim 2, wherein each sample correction function for each sample of the plurality of samples is linear.

12. The method of claim 2, wherein each sample correction function for each sample of the plurality of samples is piecewise linear.

13. The method of claim 1, wherein the plurality of sentinel ion intensity measurements comprises multiple reaction monitoring (MRM) transition measurements or mass spectrometry/mass spectrometry (MSMS) product ion measurements and the at least one non-sentinel ion intensity measurement comprises an MRM transition measurement or an MSMS product ion measurement.

14. A computer program product, comprising a non-transitory tangible computer-readable storage medium whose contents cause a processor to perform a method for correcting a measured retention time or expected retention time of an ion intensity measurement, the method comprising:
(a) providing a system, wherein the system comprises one or more distinct software modules, and wherein the distinct software modules comprise an input module and an analysis module;
(b) receiving a measured sentinel retention time for each of a plurality of sentinel ion intensity measurements using the input module, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and
(c) correcting a measured retention time or an expected retention time of at least one non-sentinel ion intensity measurement of the two or more groups using the plurality of measured sentinel retention times using the analysis module.

15. A system for correcting a measured retention time or expected retention time of an ion intensity measurement, comprising:
a processor that
(a) receives a measured sentinel retention time for each of a plurality of sentinel ion intensity measurements, wherein, during acquisition, a plurality of ion intensity measurements is divided into two or more groups so that different groups of the two or more groups are measured separately and at least one sentinel ion intensity measurement in each group of the two or more groups is selected to identify a next group of the two or more groups to be measured; and
(b) corrects a measured retention time or an expected retention time of at least one non-sentinel ion intensity measurement of the two or more groups using the plurality of measured sentinel retention times.
